(19) United States
(12) Patent Application Publication
(10) Pub. No.: US 2018/0173501 A1
(43) Pub. Date: Jun. 21, 2018

(54) FORECASTING WORKER APTITUDE USING A MACHINE LEARNING COLLECTIVE MATRIX FACTORIZATION FRAMEWORK

(71) Applicant: FUJITSU LIMITED, Kawasaki-shi (JP)

(72) Inventors: Ramya Malur SRINIVASAN, Sunnyvale, CA (US); Jorjeta Gueorguieva JETCHEVA, San Jose, CA (US); Ajay CHANDER, San Francisco, CA (US)

(73) Assignee: FUJITSU LIMITED, Kawasaki-shi (JP)

(21) Appl. No.: 15/387,605

(22) Filed: Dec. 21, 2016

(51) Int. Cl. G06F 9/44; G06N 99/00

(52) U.S. Cl. CPC G06F 8/20; G06N 99/005

(57) ABSTRACT

A computer-implemented method may include identifying multiple workers, multiple tools, and multiple taxonomy parameters. The method may also include identifying a partially-full first matrix of values representing relationships between the taxonomy parameters and the tools, a partially-full second matrix of values representing relationships between the workers and the tools, and a partially-full third matrix of values representing relationships between the workers and the taxonomy parameters. Further, the method may include employing a machine learning collective matrix factorization framework on the partially-full first, second, and third matrices to forecast the missing values of the partially-full first, second, and third matrices resulting in full first, second, and third matrices, with each forecasted value of the full second matrix representing an aptitude of the worker to be skilled in the tool and each forecasted value of the full third matrix representing an aptitude of the worker to be proficient in the taxonomy parameter.

### FIELD

The embodiments discussed herein are related to forecasting worker aptitude using a machine learning collective matrix factorization framework.

### BACKGROUND

One current trend in software development is that new software development tools (such as programming languages, frameworks, APIs, and packages, for example) are continually becoming available. Another trend in software development is that traditional computer science education focuses on teaching classical software development tools but generally fails to teach the latest software development tools. Thus, when a task is defined that requires knowledge of a new software development tool, available workers often have no skill in the new software development tool.

The subject matter claimed herein is not limited to embodiments that solve any disadvantages or that operate only in environments such as those described above. Rather, this background is only provided to illustrate one example technology area where some embodiments described herein may be practiced.

### SUMMARY

One or more embodiments of the present disclosure may include a computer-implemented method for forecasting worker aptitude. According to one embodiment, a method may include identifying multiple workers, multiple tools, and multiple taxonomy parameters. The method may also include identifying a partially-full first matrix of values representing relationships between the taxonomy parameters and the tools with each missing value representing one of the tools for which a value of the taxonomy parameter is unknown, a partially-full second matrix of values representing relationships between the workers and the tools with each missing value representing one of the tools for which a skill of the worker is unknown, and a partially-full third matrix of values representing relationships between the workers and the taxonomy parameters with each missing value representing one of the taxonomy parameters for which proficiency of the worker is unknown. Further, the method may include employing a machine learning collective matrix factorization framework on the partially-full first, second, and third matrices to forecast the missing values of the partially-full first, second, and third matrices resulting in full first, second, and third matrices, with each forecasted value of the full first matrix representing the value of the taxonomy parameter of the tool, each forecasted value of the full second matrix representing an aptitude of the worker to be skilled in the tool, and each forecasted value of the full third matrix representing an aptitude of the worker to be proficient in the taxonomy parameter.

The object and advantages of the embodiments will be realized and achieved at least by the elements, features, and combinations particularly pointed out in the claims. Both the foregoing general description and the following detailed description are exemplary and explanatory and are not restrictive.

### BRIEF DESCRIPTION OF THE DRAWINGS

Example embodiments will be described and explained with additional specificity and detail through the use of the accompanying drawings in which:

FIG. 1 illustrates an embodiment of a system for forecasting worker aptitude;

FIG. 2 illustrates an embodiment of a portion of the system for forecasting worker aptitude of FIG. 1;

FIG.3 is a flowchart of an example method for forecasting worker aptitude using a machine learning collective matrix factorization framework; and

FIG. 4 is a block diagram of an example computing device.

### DESCRIPTION OF EMBODIMENTS

As noted previously, when a task is defined that requires knowledge of a new software development tool, available workers often have no skill in the new software development tool. Therefore, it can be problematic to determine which of the available workers would be best suited for learning and using the new software development tool that is required to complete the task.

The embodiments disclosed herein may be employed to solve this and similar problems by forecasting worker aptitude using a machine learning collective matrix factorization framework. For example, the embodiments disclosed herein may be employed to forecast aptitude of available workers for learning and using a new software development tool using a machine learning collective matrix factorization framework. This forecasting may enable a determination as to which of the available workers would be best suited to be assigned to complete a task that requires use of the new software development tool. Further, the embodiments disclosed herein may also be employed to account for other constraints, such as a time constraint of the task and a time availability for each of the workers.

Thus, machine learning may be employed using the embodiments disclosed herein to accomplish what would be impossible for a human manager to accomplish without machine learning, namely, to forecast an optimum subset of available workers to perform a task even where the workers are not yet skilled in the tool or tools required to perform the task, thereby increasing the likelihood that the task will be completed on time and that the workers' time and skills will be utilized in the most efficient manner.

Embodiments of the present disclosure are now explained with reference to the accompanying drawings.

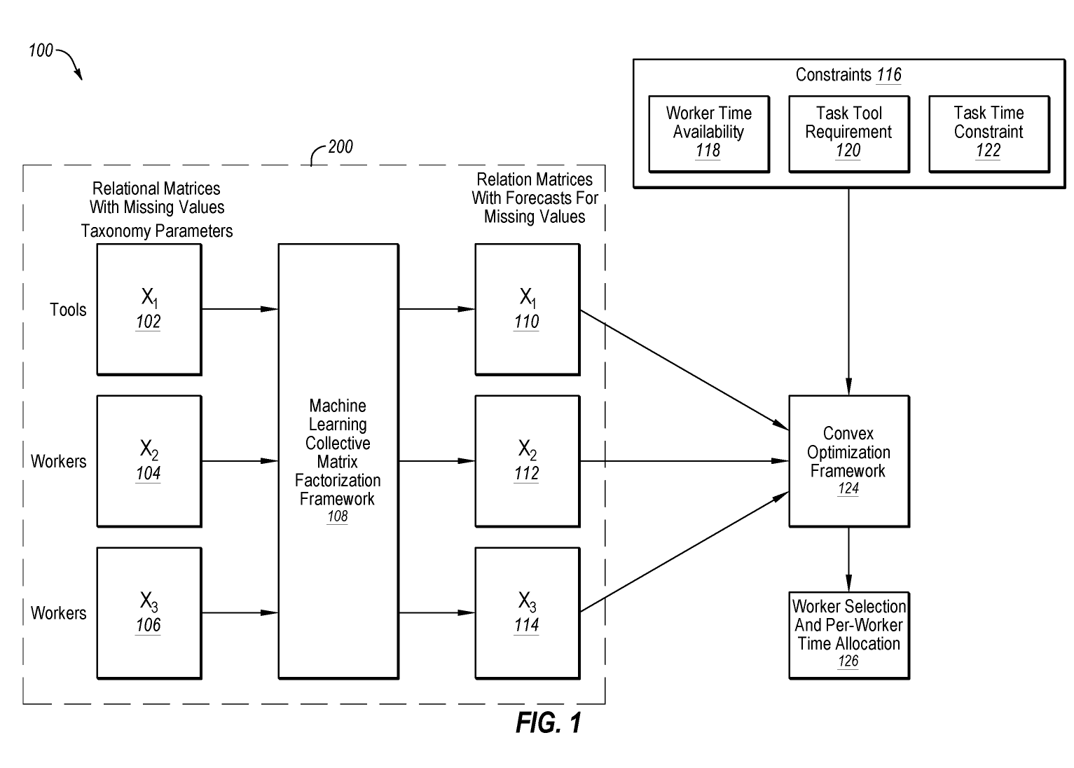

FIG. 1 illustrates an embodiment of a system 100 for forecasting worker aptitude. The system 100 may include partially-full matrices 102, 104, and 106, a machine learning collective matrix factorization framework 108, full matrices 110, 112, 114, constraints 116, a convex optimization framework 124, and a worker selection and per-worker time allocation 126.

The partially-full matrices 102, 104, and 106 may be defined as two-dimensional matrices that contain values that represent relationships between taxonomy parameters, tools, and workers.

The workers represented by the values in the partially-full matrices 104 and 106 may be workers that are available to perform a task. For example, the workers may be available workers employed by a company to perform software development tasks using software development tools. The workers may alternatively or additionally be available potential employees that a company is evaluating to decide whether the potential employees should be hired to perform a task. The workers may alternatively or additionally be available in connection with a crowdsourcing website that may grant access to hundreds or thousands of workers.

The tools represented by the values in the partially-full matrices 102 and 104 may be tools that are required to perform various tasks. For example, the tools may be software development tools and the tasks may be software development tasks. Example categories of software development tools are programming languages, frameworks, APIs, and packages.

The taxonomy parameters represented by the values in the partially-full matrices 102 and 106 may serve as a common baseline for parameterizing the workers and the tools. For example, these taxonomy parameters may include learning complexity, time to learn, ease of use, abstraction level, exploration level, or collaboration style, or some combination thereof. The taxonomy parameter learning complexity may, for a worker, refer to the level of complexity of a new tool that the worker is comfortable learning and may, for a tool, refer to the level of complexity of learning the tool. The taxonomy parameter time to learn may, for a worker, refer to the amount of time a worker is comfortable spending to learn a new tool and may, for a tool, refer to the amount of time required to learn to use the tool. The taxonomy parameter ease of use may, for a worker, refer to the level of complexity of using a tool that the worker is comfortable with and may, for a tool, refer to the level of complexity involved in the use of the tool once the tool has been learned. The taxonomy parameter abstraction level may, for a worker, refer to the level of detail that the worker is comfortable handling when interacting with tools and may, for a tool, refer to the level of detail required in order to interact with the tool (e.g., a command line interaction may require a higher level of detail than a visual drag-and-drop interaction). The taxonomy parameter exploration level may, for a worker, refer to the level of guidance the worker welcomes from the tools the worker uses and may, for a tool, refer to the level of guidance the tool provides. The taxonomy parameter collaboration style may, for a worker, refer to the level of collaboration the worker prefers and may, for a tool, refer to the level of collaboration that the tool allows.

The partially-full matrices 102, 104, and 106 may be only partially-full due to some values being missing. In particular, the values of the partially-full matrix 102 may represent relationships between the taxonomy parameters and the tools, while each missing value may represent one of the tools for which a value of the taxonomy parameter is unknown. Further, the values of the partially-full matrix 104 may represent relationships between the workers and the tools, while each missing value may represent one of the tools for which a skill of the worker is unknown. Also, the values of the partially-full matrix 106 may represent relationships between the workers and the taxonomy parameters, while each missing value may represent one of the taxonomy parameters for which proficiency of the worker is unknown.

The machine learning collective matrix factorization framework 108 may be employed on partially-full relational matrices that share the same row entities but differ in the column entities, or vice versa. For example, the partially-full matrices 104 and 106 share the same row entities (i.e., workers) but differ in the column entities (i.e., tools and taxonomy parameters). Further, the machine learning collective matrix factorization framework 108 may be employed on partially-full relational matrices with shared entities to improve forecasting accuracy by exploiting information from one relation while forecasting another. This may be accomplished by simultaneously factoring several matrices and sharing parameters among factors when an entity participates in multiple relations. Each relation may have a different value type and error distribution to allow for nonlinear relationships between parameters and outputs.

Further, the machine learning collective matrix factorization framework 108 may employ sparse group embedding to allow for factors private to arbitrary subsets of matrices by adding a group-wise sparsity constraint for the factors. In this example embodiment, the sparse group embedding may allow the machine learning collective matrix factorization framework 108 to learn facts that are specific (or private) to certain relations such as the worker-taxonomy parameter relation of the partially-full matrix 106. Also in this example embodiment, the sparse group embedding does not assume that all relations are equally important. For example, it may not give equal importance to the worker-taxonomy parameter relation of the partially-full matrix 106, the worker-tool relation of the partially-full matrix 104, and the taxonomy parameter-tool relation of the partially-full matrix 102, which allows for the weighting of certain relations more than others in forecasting a missing value. This unequal weighting may be justified, for example, in a situation where a worker's skill in programming using Amazon Web Services is correlated with the worker learning the Apache programming language more quickly, or a worker's skill in the C++ programming language is correlated with the worker learning the Python programming language more quickly. Similarly, this unequal weighting may be justified where a worker is comfortable with complex tasks, so that even though there may be a weaker correlation between the C and Python programming languages, the worker may be a good choice to be assigned to the task where the worker is skilled in the Python programming language but is not skilled in the C programming language.

The machine learning collective matrix factorization framework 108 may be similar to the collective matrix factorization framework described in “Relational Learning via Collective Matrix Factorization,” Ajit P. Singh and Geoffrey J. Gordon, Proceedings of the 14th ACM SIGKDD International Conference on Knowledge Discovery and Data Mining, 2008, Pages 650-658, or similar to the collective matrix factorization framework described in “Group-sparse Embeddings in Collective Matrix Factorization,” Arto Klami, Guillaume Bouchard, and Abhishek Tripathi, submitted for International Conference on Learning Representations 2014, version 2 last revised 18 Feb. 2014, arXiv:1312.5921v2 [stat.ML] (the “Klami Paper”), both of which documents are incorporated herein by reference in their entireties.

The machine learning collective matrix factorization framework 108 may be employed on the partially-full matrices 102, 104, and 106 to forecast the missing values of the partially-full matrices 102, 104, and 106 resulting in the full matrices 110, 112, and 114. Once the missing values have been forecasted, each forecasted value of the full matrix 110 may represent the value of the taxonomy parameter of the tool, each forecasted value of the full matrix 112 may represent an aptitude of the worker to be skilled in the tool, and each forecasted value of the full matrix 114 may represent an aptitude of the worker to be proficient in the taxonomy parameter.

The constraints 116 may be defined as constraints on a task. For example, a task may be defined by a task tool requirement 120 and a task time constraint 122. In addition, other constraints may be associated with a task, such as worker time availability 118.

The convex optimization framework 124 may be employed on the full matrices 110, 112, and 114 to forecast an optimum subset of the workers to perform the task and to forecast an optimum amount of time that each of the optimum subset of the workers should devote to the task based on the task tool requirement 120, the task time constraint 122, and the worker time availability 118, resulting in the worker selection and per-worker time allocation 126. Therefore, instead of focusing only on worker availability and task time constraints, the convex optimization framework 124 takes into account the skill set required by the task, as defined by the task tool requirement 120. The convex optimization framework 124 may be implemented using CVX, Version 2.1, October 2016, Build 1112, which is a Matlab-based modeling system for convex optimization.

In addition, the forecasting of the convex optimization framework 124 may also be based on a quality of work constraint that includes a total time to complete the task constrained between a minimum time period and a maximum time period. Additionally or alternatively, the forecasting of the convex optimization framework 124 may also be based on a worker collaboration constraint that includes having two of the workers who are compatible included in the optimum subset of the workers or that includes having two of the workers who are not compatible not both being included in the optimum subset of the workers.

Thus, the system 100 may be employed to forecast aptitude of available workers for learning and using a new tool using the machine learning collective matrix factorization framework 108. This forecasting may enable a determination as to which of the available workers would be best suited to be assigned to complete a task that requires use of the new tool. Thus, the machine learning collective matrix factorization framework 108 may be employed in the system 100 to accomplish what it would be impossible for a human manager to accomplish without machine learning, namely, to forecast an optimum subset of available workers to perform a task even where the workers are not yet skilled in the tool or tools required to perform the task, thereby increasing the likelihood that the task will be completed on time and that the workers' time and skills will be utilized in the most efficient manner.

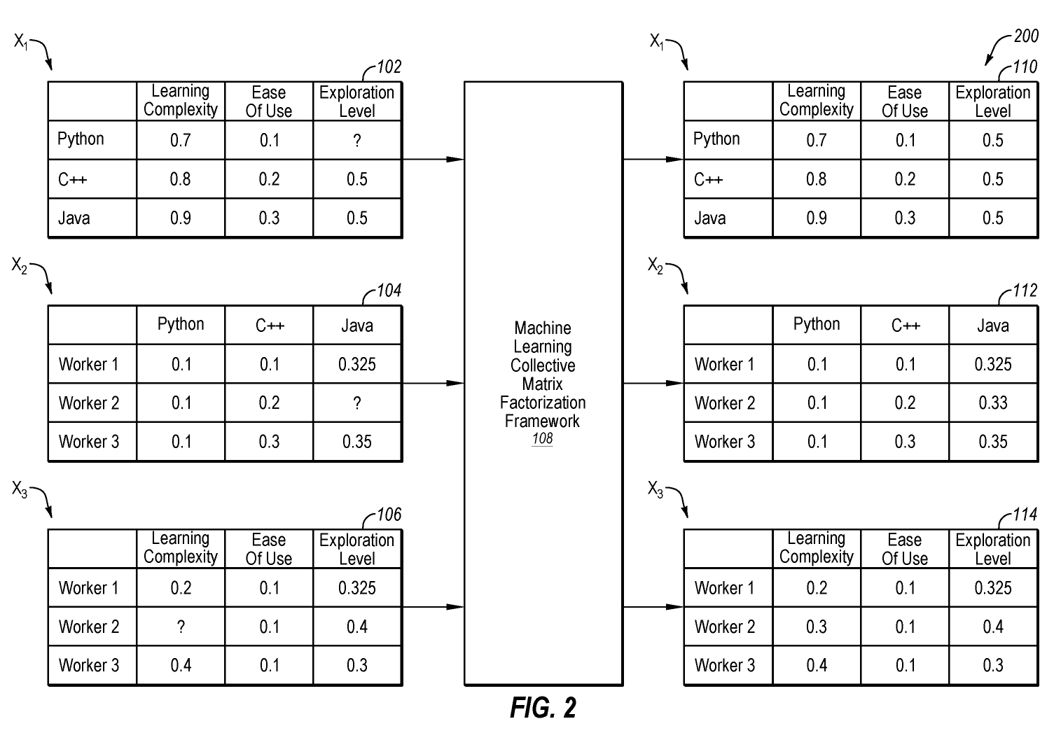

FIG. 2 illustrates an embodiment of a portion 200 of the system 100 for forecasting worker aptitude of FIG. 1. The portion 200 includes the partially-full matrices 102, 104, and 106, the machine learning collective matrix factorization framework 108, and the full matrices 110, 112, 114. In the embodiment of FIG. 2, the tools are software development tools, namely, the Python, C++, and Java programming languages, the workers are worker 1, worker 2, and worker 3, and the taxonomy parameters are learning complexity, ease of use, and exploration level.

As disclosed in FIG. 2, the values in the partially-full matrices 102, 104, and 106 and the full matrices 110, 112, 114 are values between 0 and 1, with 0 indicating the lowest value and 1 indicating the highest value. For example, the value of 0.1 in the upper-left-hand cell and the value of 0.325 in the upper-right-hand cell of the partially-full matrix 104 indicate that worker 1 is more skilled at the Java programming language than at the Python programming language. In this context, it is understood that skill in a particular programming language may be tied to a particular worker's preference for the particular programming language, since there may generally be a symbiotic relationship between a worker preferring a particular programming language and the worker being skilled in the particular programming language. Therefore, skill and preference may, in at least some embodiments, be interchangeable. Also disclosed in FIG. 2, each of the partially-full matrices 102, 104, and 106 of FIG. 2 is missing a value, represented by a question mark. In particular, the missing value of the partially-full matrix 102 indicates that the exploration level of Python is unknown, the missing value of the partially-full matrix 104 indicates that the skill of worker 2 in Java is unknown, and the missing value of the partially-full matrix 106 indicates that the proficiency of worker 2 in learning complexity is unknown. In this context, it is understood that unknown may indicate lack of skill, such as in the context of the partially-full matrix 104.

The values in the partially-full matrices 102, 104, and 106 may be obtained in a variety of ways, including surveys, observations, and testing. For example, the values in the partially-full matrices 104 and 106 may be obtained by surveying workers 1, 2, and 3 regarding the software development tools listed in the columns of the partially-full matrix 104 and regarding the taxonomy parameters listed in the columns of the partially-full matrix 106. In this example, the missing value in the partially-full matrix 104 may result from worker 2 indicating in the survey that worker 2 is not yet skilled in the programming language Java. Similarly, in this example, the missing value in the partially-full matrix 106 may result from the worker 2 leaving blank an answer to a question in the survey regarding the level of complexity of a new tool that the worker is comfortable learning.

As disclosed in FIG. 2, the machine learning collective matrix factorization framework 108 may be employed to forecast the value of the exploration level of the programming language Python, to forecast the aptitude of worker 2 to be skilled in the programming language Java, and to forecast the aptitude of worker 2 to be proficient in learning complexity. This forecasting may enable a determination as to which of the available workers 1, 2, and 3 would be best suited to be assigned to complete a task that requires use of a particular one of the Python, C++, and Java programming languages.

With reference now to FIGS. 1 and 2, one embodiment may include the machine learning collective matrix factorization framework 108 being trained for a particular number of iterations, such as ten iterations, prior to being employed on the partially-full matrices 102, 104, and 106 to forecast the missing values of the partially-full matrices 102, 104, and 106. In this embodiment, the number of underlying factors for the machine learning collective matrix factorization framework 108 may be set to a particular number, such as two underlying factors, which may be a number that is decided based on validations error, with the factor that gives the minimum error being chosen. Also in this embodiment, the index of the object sets that constitutes the partially-full matrices 102, 104, and 106 may be (1,2), (3, 2), (3,1), meaning that the partially-full matrix 102 is formed from taxonomy parameters as columns and tools as rows, the partially-full matrix 104 is formed by workers as rows and tools as columns, and the partially-full matrix 106 is formed by workers as rows and taxonomy parameters as columns.

In this embodiment, the machine learning collective matrix factorization framework 108 may be employed on the partially-full matrices 102, 104, and 106, resulting in the full matrices 110, 112, and 114. Further, in this embodiment, the worker time availability 118 may be worker 1<=100 hours, worker 2<=40 hours, and worker 3<=120 hours, the task tool requirement 120 may be use of the Python and C++ programming languages, and the task time constraint 122 may be a task completion of <=100 hours. It is noted that the Python programming language is represented in the top row of the full matrix 110 by the taxonomy parameter vector [0.7, 0.1, 0.5] and the C++ programming language is represented in the middle row of the full matrix 110 by the taxonomy parameter vector [0.8, 0.2, 0.5]. In order to combine these two taxonomy parameter vectors into one vector that characterizes the taxonomy parameters for the task under consideration, any one of various aggregation strategies may be employed. The aggregation strategy employed may be based on the semantics of the taxonomy parameters or the complexity of the implementation. For example, the aggregation strategy may be any of the following aggregation strategies, or some combination thereof: maximum, minimum, plurality voting, average, multiplicative, borda count, copeland rule, approval voting, least misery, most pleasure, average without misery, fairness, or most respected. In this embodiment, the maximum value can be used to combine the first element (corresponding to learning complexity), the minimum value can be used to combine the second element (corresponding to ease of use), and the average value can be used to combine the third element (corresponding to exploration level). These combinations result in a taxonomy parameter vector [0.8, 0.1, 0.5] corresponding to the task under consideration.

In this embodiment, the convex optimization framework 124 may then be employed on the full matrices 110, 112, and 114 to forecast an optimum subset of the workers to perform the task and to forecast an optimum amount of time that each of the optimum subset of the workers should devote to the task. In particular, given that worker 1 may be characterized by the taxonomy parameter vector [0.2, 0.1, 0.325], worker 2 may be characterized by the taxonomy parameter vector [0.3, 0.1, 0.4], and worker 3 may be characterized by the taxonomy parameter vector [0.4, 0.1, 0.3], and the Python and C++ programming languages may be characterized by the combined taxonomy parameter vector [0.4, 0.1, 0.3], and based on the worker time availability 118 of worker 1<=100 hours, worker 2<=40 hours, and worker 3<=120 hours, and based on the task time constraint of a task completion of <=100 hours, the convex optimization framework 124 may then be employed to forecast the optimum subset of the workers to perform the task to be worker 1 and to forecast an optimum amount of time that worker 1 should devote to the task to be 100 hours.

In another embodiment, that is similar to the previous embodiment except that the worker time availability 118 is changed to worker 1<=60 hours, worker 2<=40 hours, and worker 3<=120 hours, the convex optimization framework 124 may be employed to forecast the optimum subset of the workers to perform the task to be worker 1 and worker 3 and to forecast an optimum amount of time that worker 1 and worker 3 should devote to the task to be 60 hours for worker 1 and 40 hours for worker 3.

In another embodiment, the operations performed by the system 100 of FIG. 1 and the portion 200 of the system 100 of FIG. 2 may be expressed as follows:
Let T be a task that can be completed by a set of tools defined by tools=[D₁, D₂, . . . Dₙ]
Let G be a group consisting of workers W=[W₁, W₂, . . . W_{d3}]
Let α be the total time allowed for the task.
Let α₁, α₂, . . . α_{d3} denote the individual worker's time constraints in order to complete the task.
A possible constraint could be that α₁+α₂, . . . +α_{d3}<=α
Each tool and worker may be characterized along the taxonomy vectors TP=[TP₁, TP₂, . . . TP_{d1}]

In this embodiment, the missing values of these vectors may be obtained by the machine learning collective matrix factorization framework 108, in which:
Let X₁=[xᵢⱼ⁽¹⁾] describe the relationship between taxonomy parameters (entity E₁) and tools (entity E₁), i.e., the average ratings across many workers for the d₁ TP across all the d₂ tools.
Let X₂=[xᵢⱼ⁽²⁾] describe the relationship between workers and the tools, i.e., the preference ratings of d₃ workers for d₂ tools.
Let X₃=[xᵢⱼ⁽³⁾] describe the relationship between workers (entity E₃) and taxonomy parameters (entity E₁), i.e., the individual ratings of d₃ workers for d₁ taxonomy parameters.
Thus, we have three entity sets E={E₁=TP, E₂=tools, E₃=workers} and three relational matrices with dimensions dₑ as mentioned above.

In this embodiment, once the missing values are obtained using the machine learning collective matrix factorization framework 108, the next step is to obtain a single task vector characterized by the tool requirements along the taxonomy parameters, as follows:
Assume that a task T can be completed by a set of tools given by D₁, D₂, . . . Dₙ
The machine learning collective matrix factorization framework 108 ensures that each tool is characterized by its own set of taxonomy parameters (TP).
Thus, we have,

D₁=[TP₁¹, TP₂¹, . . . TP_{d1}¹], D₂=[TP₁², TP₂², . . . TP_{d1}²], . . . Dₙ[TP₁ⁿ, TP₂ⁿ, . . . TP_{d1}ⁿ]
We characterize the task T by a single TP vector in terms of its taxonomy parameters.
In obtaining this, based on the TP, appropriate merging schemes may be employed.
   For example, if the TP is related to the learning complexity of the tool, then the maximum value of the complexity among all tools may be chosen (most pleasure scheme).
   On the other hand, if the TP is related to the learning complexity of the worker, then the minimum value among all tools has may be chosen (least misery scheme).
   For unambiguous cases, average values across all tools may be chosen (average scheme).

In this embodiment, we now have the following:
A task T characterized along the TP: T=[TP₁^{T}, TP₂^{T}, . . . TP_{d1}^{T}]
A group consisting of workers W=[W₁, W₂, . . . W_{d3}]
The members of the group are characterized by their individual TPs and their time constraints. Thus,
   W₁=a vector of TP values for worker 1 with time constraint ai
   W₂=a vector of TP values for worker 2 with time constraint az and so on.
Thus the problem now becomes solving the following:
   T=α₁ W₁+α₂W₂+α₃ W₃+ . . . α_{d3}, subject to the time constraints on alphas, which may be solved using the convex optimization framework 124, resulting in the worker selection and per-worker time allocation 126.

In this embodiment, constraints may also be chosen to incorporate conditions such as:
Quality of Work—To ensure that the work completed for a task meets certain requirements and is of good quality, a constraint can be added so that the total time to complete the task a is in an interval [t₁<α<t₂]. This may help avoid a task being of low quality because the task is completed too quickly and avoid the task being completed in an inefficient manner because it takes too much time to complete.
Worker Collaboration—Due to some workers not being compatible to work together or due to some workers always wanting to work together, constraints can be incorporated by choosing conditions such as if α₁>0 then α₂=0 (and vice versa) or if α₁>0 then α₂>0 (and vice versa), respectively. Note that the constraint if α₁>0 then α₂>0 (and vice versa) may be non-convex and therefore require a non-convex numerical estimation method to solve, which solution may be more difficult to achieve than a solution to a convex optimization problem.

In another embodiment, the operations performed by the system 100 of FIG. 1 and the portion 200 of the system 100 of FIG. 2 may be expressed as follows:
Each relational matrix Xₘ may be approximated by a low rank representation as follows:

xᵢⱼ^{(m)}=_{K}Σ uᵢₖ^{(r}ₘ⁾ uⱼₖ^{(c}ₘ⁾+bᵢ^{(m,r)}+bⱼ^{(m,c)}+εᵢⱼ^{(m)}
where Uₑ=[uᵢₖ^{(c)}] is the low rank matrix related to the entity set e, bᵢ^{(m,r)} and bⱼ^{(m,c)} are the bias terms for the m^{th} matrix and εᵢⱼ^{(m)} is the element-wise independent noise.
A large single matrix Y may contain all Xₘ such that blocks not corresponding to any X are left unobserved (blank) is constructed with corresponding one large entity set with d=_{E}Σ d_{c}
The model can then be formulated as a symmetric matrix factorization as follows:

Y=UU^{T}+_{ε}
where U˜R^{d}*^{K} is the column-wise concatenation of all Uₑ matrices and c is the overall noise term.
If the kth column of the factor matrices Uₑ are null for all but two entity types rₘ and cm, it may imply that the kth factor is a private factor for relation m. To allow the automatic creation of these private factors, group sparse priors on the columns of Uₑ may be imposed as disclosed in the Klami Paper.
The model may be instantiated by specifying Gaussian likelihood and Gamma priors for the projections, so that:

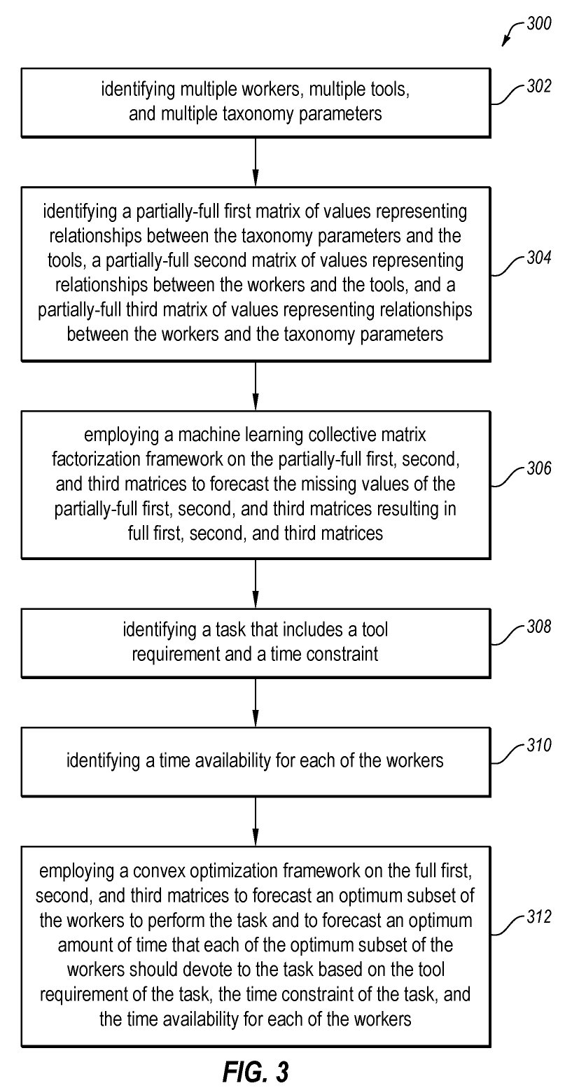

εᵢⱼ^{(m)}˜N(0,τₘ⁻¹), τₘ˜Gamma(p₀, q₀), uᵢₖ^{(e)}˜N(0,α_{ck}⁻¹) and α_{ck}·Gamma(a₀, b₀)
where e is the entity set that contains entity i.
The prior for u automatically selects for each factor a set of matrices for which it is active by learning large precision values α_{ck} for factors k that may not be needed for modeling variation of entity set e.
Variational Bayesian approximation is used to learn the model parameters as disclosed in the Klami Paper.
   FIG. 3 is a flowchart of an example method 300 for forecasting worker aptitude using a machine learning collective matrix factorization framework, arranged in accordance with at least one embodiment described in the present disclosure. The method 300 may be performed by any suitable system, apparatus, or device. For example, system 100 of FIG. 1 or one or more of the components thereof may perform one or more of the operations associated with method 300. In these and other embodiments, computer-executable instructions stored on non-transitory computer-readable media may be executed to perform one or more of the operations of method 300. Although illustrated as discrete blocks, various blocks may be divided into additional blocks, combined into fewer blocks, or eliminated, depending on the target implementation. Further, the blocks may be implemented in differing order. For example, the blocks 308-312 may be eliminated.

At block 302, multiple workers, multiple tools, and multiple taxonomy parameters may be identified. For example, as disclosed in connection with FIGS. 1 and 2, the workers may be workers that are available to perform a task, the tools may be tools that are required to perform various tasks, and the taxonomy parameters may serve as a common baseline for parameterizing the workers and the tools. In one example embodiment, the tools may be software development tools.

At block 304, partially-full first, second, and third matrices may be identified. The partially-full first matrix of values may represent relationships between the taxonomy parameters and the tools, the partially-full second matrix of values may represent relationships between the workers and the tools, and the partially-full third matrix of values may represent relationships between the workers and the taxonomy parameters. For example, as disclosed in connection with FIGS. 1 and 2, the values of the partially-full matrix 102 may represent relationships between the taxonomy parameters and the tools, while each missing value may represent one of the tools for which a value of the taxonomy parameter is unknown. Further, the values of the partially-full matrix 104 may represent relationships between the workers and the tools, while each missing value may represent one of the tools for which a skill of the worker is unknown. Also, the values of the partially-full matrix 106 may represent relationships between the workers and the taxonomy parameters, while each missing value may represent one of the taxonomy parameters for which proficiency of the worker is unknown.

At block 306, a machine learning collective matrix factorization framework may be employed on the partially-full first, second, and third matrices to forecast the missing values of the partially-full first, second, and third matrices resulting in full first, second, and third matrices. For example, as disclosed in connection with FIGS. 1 and 2, the machine learning collective matrix factorization framework 108 may be employed on the partially-full matrices 102, 104, and 106 to forecast the missing values of the partially-full matrices 102, 104, and 106 resulting in the full matrices 110, 112, and 114. Further, each forecasted value of the full matrix 110 may represent the value of the taxonomy parameter of the tool, each forecasted value of the full matrix 112 may represent an aptitude of the worker to be skilled in the tool, and each forecasted value of the full matrix 114 may represent an aptitude of the worker to be proficient in the taxonomy parameter.

At block 308, a task may be identified that includes a tool requirement and a time constraint. For example, as disclosed in connection with FIG. 1, the task may be defined by a task tool requirement 120 and a task time constraint 122. In one example embodiment, the task may be a software development task.

At block 310, a time availability for each of the workers may be identified. For example, as disclosed in connection with FIG. 1, the worker time availability 118 may be identified and associated with the task that was identified at block 308.

At block 312, a convex optimization framework may be employed on the full first, second, and third matrices to forecast an optimum subset of the workers to perform the task and to forecast an optimum amount of time that each of the optimum subset of the workers should devote to the task based on the tool requirement of the task, the time constraint of the task, and the time availability for each of the workers. For example, as disclosed in connection with FIG. 1, the convex optimization framework may be employed on the full matrices 110, 112, and 114 to forecast an optimum subset of the workers to perform the task and to forecast an optimum amount of time that each of the optimum subset of the workers should devote to the task based on the task tool requirement 120, the task time constraint 122, and the worker time availability 118, resulting in the worker selection and per-worker time allocation 126. In addition, the block 312 may further include granting access to hardware and/or software resources associated with the task to each of the optimum subset of the workers. For example, only the subset of workers may be granted access to computer hardware or computer software that are associated with the task, such as the software development tools associated with the task, while the other workers who are available but are not in the subset of workers are denied access to the same computer hardware or computer software that are associated with the task, thus providing access control for the tools associated with the task.

The method 300 may therefore be employed to forecast aptitude of available workers for learning and using a new tool or tools using a machine learning collective matrix factorization framework. This forecasting may enable a determination as to which of the available workers would be best suited to be assigned to complete a task that requires use of the new tool. Thus, a machine learning collective matrix factorization framework may be employed in the method 300 to accomplish what it would be impossible for a human manager to accomplish without machine learning, namely, to forecast an optimum subset of available workers to perform a task even where the workers are not yet skilled in the tool or tools required to perform the task, thereby increasing the likelihood that the task will be completed on time and that the workers' time and skills will be utilized in the most efficient manner.

Although the method 300 has been discussed in the context of software development tools and an example software development task, it is understood that the method 300 may be equally applicable in the context of physical labor tools and tasks such as construction tools and tasks where the workers are physical laborers, project management tools and tasks where the workers are managers, or medical tools and tasks where the workers are medical personnel such as doctors and nurses, or any combination of tools and tasks such as in the context of a hybrid task that includes both physical labor and software development.

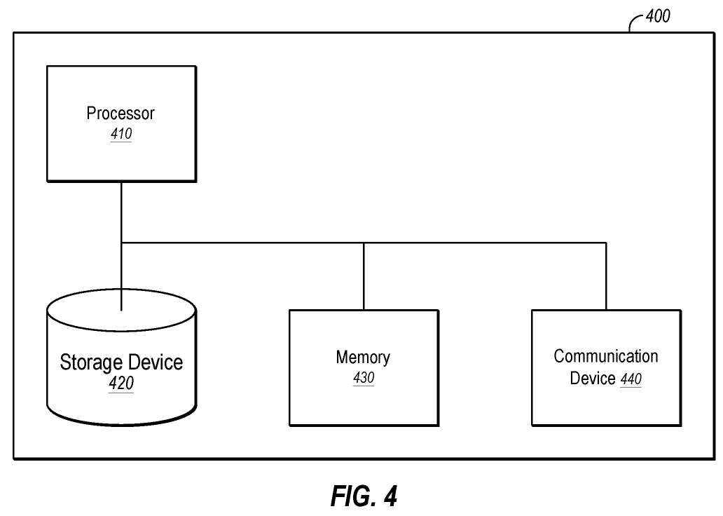

FIG. 4 is a block diagram of an example computing device 400, in accordance with at least one embodiment of the present disclosure. For example, the system 100 of FIG. 1 may be implemented on computing device 400. Computing device 400 may include a desktop computer, a laptop computer, a server computer, a tablet computer, a mobile phone, a smartphone, a personal digital assistant (PDA), an e-reader device, a network switch, a network router, a network hub, other networking devices, or other suitable computing device.

Computing device 400 may include a processor 410, a storage device 420, a memory 430, and a communication device 440. Processor 410, storage device 420, memory 430, and/or communication device 440 may all be communicatively coupled such that each of the components may communicate with the other components. Computing device 400 may perform any of the operations described in the present disclosure.

In general, processor 410 may include any suitable special-purpose or general-purpose computer, computing entity, or processing device including various computer hardware or software modules and may be configured to execute instructions stored on any applicable computer-readable storage media. For example, processor 410 may include a microprocessor, a microcontroller, a digital signal processor (DSP), an application-specific integrated circuit (ASIC), a Field-Programmable Gate Array (FPGA), or any other digital or analog circuitry configured to interpret and/or to execute program instructions and/or to process data. Although illustrated as a single processor in FIG. 4, processor 410 may include any number of processors configured to perform, individually or collectively, any number of operations described in the present disclosure.

In some embodiments, processor 410 may interpret and/or execute program instructions and/or process data stored in storage device 420, memory 430, or storage device 420 and memory 430. In some embodiments, processor 410 may fetch program instructions from storage device 420 and load the program instructions in memory 430. After the program instructions are loaded into memory 430, processor 410 may execute the program instructions.

For example, in some embodiments one or more of the processing operations of a process chain may be included in storage device 420 as program instructions. Processor 410 may fetch the program instructions of one or more of the processing operations and may load the program instructions of the processing operations in memory 430. After the program instructions of the processing operations are loaded into memory 430, processor 410 may execute the program instructions such that computing device 400 may implement the operations associated with the processing operations as directed by the program instructions.

Storage device 420 and memory 430 may include computer-readable storage media for carrying or having computer-executable instructions or data structures stored thereon. Such computer-readable storage media may include any available media that may be accessed by a general-purpose or special-purpose computer, such as processor 410. By way of example, and not limitation, such computer-readable storage media may include tangible or non-transitory computer-readable storage media including RAM, ROM, EEPROM, CD-ROM or other optical disk storage, magnetic disk storage or other magnetic storage devices, flash memory devices (e.g., solid state memory devices), or any other storage medium which may be used to carry or store desired program code in the form of computer-executable instructions or data structures and which may be accessed by a general-purpose or special-purpose computer. Combinations of the above may also be included within the scope of computer-readable storage media. Computer-executable instructions may include, for example, instructions and data configured to cause the processor 410 to perform a certain operation or group of operations.

In some embodiments, storage device 420 and/or memory 430 may store data associated with a deep learning system. For example, storage device 420 and/or memory 430 may store encoded activation addresses, encoded weight addresses, and/or one or more dictionaries.

Communication device 440 may include any device, system, component, or collection of components configured to allow or facilitate communication between computing device 400 and another electronic device. For example, communication device 440 may include, without limitation, a modem, a network card (wireless or wired), an infrared communication device, an optical communication device, a wireless communication device (such as an antenna), and/or chipset (such as a Bluetooth device, an 802.6 device (e.g. Metropolitan Area Network (MAN)), a Wi-Fi device, a WiMAX device, cellular communication facilities, etc.), and/or the like. Communication device 440 may permit data to be exchanged with any network such as a cellular network, a Wi-Fi network, a MAN, an optical network, etc., to name a few examples, and/or any other devices described in the present disclosure, including remote devices.

Modifications, additions, or omissions may be made to FIG. 4 without departing from the scope of the present disclosure. For example, computing device 400 may include more or fewer elements than those illustrated and described in the present disclosure. For example, computing device 400 may include an integrated display device such as a screen of a tablet or mobile phone or may include an external monitor, a projector, a television, or other suitable display device that may be separate from and communicatively coupled to computing device 400.

As used in the present disclosure, the terms “module” or “component” may refer to specific hardware implementations configured to perform the actions of the module or component and/or software objects or software routines that may be stored on and/or executed by general purpose hardware (e.g., computer-readable media, processing devices, etc.) of the computing system. In some embodiments, the different components, modules, engines, and services described in the present disclosure may be implemented as objects or processes that execute on the computing system (e.g., as separate threads). While some of the system and methods described in the present disclosure are generally described as being implemented in software (stored on and/or executed by general purpose hardware), specific hardware implementations or a combination of software and specific hardware implementations are also possible and contemplated. In the present disclosure, a “computing entity” may be any computing system as previously defined in the present disclosure, or any module or combination of modulates running on a computing system.

Terms used in the present disclosure and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

All examples and conditional language recited in the present disclosure are intended for pedagogical objects to aid the reader in understanding the invention and the concepts contributed by the inventor to furthering the art, and are to be construed as being without limitation to such specifically recited examples and conditions. Although embodiments of the present disclosure have been described in detail, various changes, substitutions, and alterations could be made hereto without departing from the spirit and scope of the present disclosure.

What is claimed is:

1. Non-transitory computer-readable storage media including computer-executable instructions configured to cause a system to perform operations for forecasting worker aptitude, the operations comprising:
identifying multiple workers, multiple tools, and multiple taxonomy parameters;
identifying a partially-full first matrix of values representing relationships between the taxonomy parameters and the tools with each missing value representing one of the tools for which a value of the taxonomy parameter is unknown, a partially-full second matrix of values representing relationships between the workers and the tools with each missing value representing one of the tools for which a skill of the worker is unknown, and a partially-full third matrix of values representing relationships between the workers and the taxonomy parameters with each missing value representing one of the taxonomy parameters for which proficiency of the worker is unknown;
employing a machine learning collective matrix factorization framework on the partially-full first, second, and third matrices to forecast the missing values of the partially-full first, second, and third matrices resulting in full first, second, and third matrices, each forecasted value of the full first matrix representing the value of the taxonomy parameter of the tool, each forecasted value of the full second matrix representing an aptitude of the worker to be skilled in the tool, each forecasted value of the full third matrix representing an aptitude of the worker to be proficient in the taxonomy parameter;
identifying a task that includes a tool requirement and a time constraint;
identifying a time availability for each of the workers; and
employing a convex optimization framework on the full first, second, and third matrices to forecast an optimum subset of the workers to perform the task and to forecast an optimum amount of time that each of the optimum subset of the workers should devote to the task based on the tool requirement of the task, the time constraint of the task, and the time availability for each of the workers.

2. The non-transitory computer-readable storage media of claim 1, wherein the tools are software development tools and the task is a software development task.

3. The non-transitory computer-readable storage media of claim 2, wherein the taxonomy parameters include learning complexity, time to learn, ease of use, abstraction level, exploration level, or collaboration style, or some combination thereof.

4. The non-transitory computer-readable storage media of claim 3, wherein the values in the partially-full and the full first, second, and third matrices are values between 0 and 1.

5. The non-transitory computer-readable storage media of claim 1, wherein the employing of the convex optimization framework on the full first, second, and third matrices to forecast the optimum subset of the workers to perform the task and to forecast the optimum amount of time that each of the optimum subset of the workers should devote to the task is further based on a quality of work constraint that includes a total time to complete the task constrained between a minimum time period and a maximum time period.

6. The non-transitory computer-readable storage media of claim 1, wherein the employing of the convex optimization framework on the full first, second, and third matrices to forecast the optimum subset of the workers to perform the task and to forecast the optimum amount of time that each of the optimum subset of the workers should devote to the task is further based on a worker collaboration constraint that includes having two of the workers who are compatible included in the optimum subset of the workers or that includes having two of the workers who are not compatible not both included in the optimum subset of the workers.

7. The non-transitory computer-readable storage media of claim 1, wherein the operations further comprise granting access to hardware and/or software resources associated with the task to each of the optimum subset of the workers.

8. A computer-implemented method for forecasting worker aptitude, the method comprising:
identifying multiple workers, multiple tools, and multiple taxonomy parameters;
identifying a partially-full first matrix of values representing relationships between the taxonomy parameters and the tools with each missing value representing one of the tools for which a value of the taxonomy parameter is unknown, a partially-full second matrix of values representing relationships between the workers and the tools with each missing value representing one of the tools for which a skill of the worker is unknown, and a partially-full third matrix of values representing relationships between the workers and the taxonomy parameters with each missing value representing one of the taxonomy parameters for which proficiency of the worker is unknown;
employing a machine learning collective matrix factorization framework on the partially-full first, second, and third matrices to forecast the missing values of the partially-full first, second, and third matrices resulting in full first, second, and third matrices, each forecasted value of the full first matrix representing the value of the taxonomy parameter of the tool, each forecasted value of the full second matrix representing an aptitude of the worker to be skilled in the tool, each forecasted value of the full third matrix representing an aptitude of the worker to be proficient in the taxonomy parameter;
identifying a task that includes a tool requirement and a time constraint;
identifying a time availability for each of the workers; and
employing a convex optimization framework on the full first, second, and third matrices to forecast an optimum subset of the workers to perform the task and to forecast an optimum amount of time that each of the optimum subset of the workers should devote to the task based on the tool requirement of the task, the time constraint of the task, and the time availability for each of the workers.

9. The computer-implemented method of claim 8, wherein the tools are software development tools and the task is a software development task.

10. The computer-implemented method of claim 9, wherein the taxonomy parameters include learning complexity, time to learn, ease of use, abstraction level, exploration level, or collaboration style, or some combination thereof.

11. The computer-implemented method of claim 10, wherein the values in the partially-full and the full first, second, and third matrices are values between 0 and 1.

12. The computer-implemented method of claim 8, wherein the employing of the convex optimization framework on the full first, second, and third matrices to forecast the optimum subset of the workers to perform the task and to forecast the optimum amount of time that each of the optimum subset of the workers should devote to the task is further based on a quality of work constraint that includes a total time to complete the task constrained between a minimum time period and a maximum time period.

13. The computer-implemented method of claim 8, wherein the employing of the convex optimization framework on the full first, second, and third matrices to forecast the optimum subset of the workers to perform the task and to forecast the optimum amount of time that each of the optimum subset of the workers should devote to the task is further based on a worker collaboration constraint that includes having two of the workers who are compatible included in the optimum subset of the workers or that includes having two of the workers who are not compatible not both included in the optimum subset of the workers.

14. The computer-implemented method of claim 8, further comprising granting access to hardware and/or software resources associated with the task to each of the optimum subset of the workers.

15. The computer-implemented method of claim 8, wherein the machine learning collective matrix factorization framework employs sparse group embedding.

16. A computer-implemented method for forecasting worker aptitude, the method comprising:
identifying multiple workers, multiple tools, and multiple taxonomy parameters;
identifying a partially-full first matrix of values representing relationships between the taxonomy parameters and the tools with each missing value representing one of the tools for which a value of the taxonomy parameter is unknown, a partially-full second matrix of values representing relationships between the workers and the tools with each missing value representing one of the tools for which a skill of the worker is unknown, and a partially-full third matrix of values representing relationships between the workers and the taxonomy parameters with each missing value representing one of the taxonomy parameters for which proficiency of the worker is unknown; and
employing a machine learning collective matrix factorization framework on the partially-full first, second, and third matrices to forecast the missing values of the partially-full first, second, and third matrices resulting in full first, second, and third matrices, each forecasted value of the full first matrix representing the value of the taxonomy parameter of the tool, each forecasted value of the full second matrix representing an aptitude of the worker to be skilled in the tool, each forecasted value of the full third matrix representing an aptitude of the worker to be proficient in the taxonomy parameter.

17. The computer-implemented method of claim 16, wherein the tools are software development tools.

18. The computer-implemented method of claim 17, wherein the taxonomy parameters include learning complexity, time to learn, ease of use, abstraction level, exploration level, or collaboration style, or some combination thereof.

19. The computer-implemented method of claim 18, wherein the values in the partially-full and the full first, second, and third matrices are values between 0 and 1.

20. The computer-implemented method of claim 16, wherein the machine learning collective matrix factorization framework employs sparse group embedding.
